(19) United States
(12) Patent Application Publication
(10) Pub. No.: US 2009/0279093 A1
(43) Pub. Date: Nov. 12, 2009

(54) INTEGRATED BIOSENSING DEVICE HAVING PHOTO DETECTOR

(75) Inventors: Maarten Marinus Johannes Wilhelmus Van Herpen, Eindhoven (NL); Derk Jan Wilfred Klunder, Eindhoven (NL); Marcello Leonardo Mario Balistreri, Eindhoven (NL); Mark Thomas Johnson, Eindhoven (NL); Marc Wilhelmus Gijsbert Ponjee, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/304,288

(22) PCT Filed: May 15, 2007
(86) PCT No.: PCT/IB07/51833

§ 371 Date: Dec. 11, 2008

(30) Foreign Application Priority Data
Jun. 15, 2006 (EP) 06115530.5

(51) Int. Cl. G01N 21/25; G01N 21/64; B23P 11/00

(52) U.S. Cl. 356/417; 29/428

(57) ABSTRACT

An integrated biosensing device detects emissions from a sample when illuminated. A photo detector (20) is adjacent a site for retaining the sample (40) or receiving excitation radiation for impingement on the sample (40). A reflector (10) deflects the illumination onto the sample site and substantially guides the excitation radiation away from the photo detector. By providing a reflector, a ratio of desired detection of emissions to unwanted detection of the illumination light can be improved. This can be achieved by a reduction in an amount of the illumination reaching the photo detector, and/or by an increase in the amount of illumination of the sample and thus in the amount of emissions reaching the detector. This can be achieved more cost effectively than by using a filter. The illumination can be from above or below if the substrate is transparent.

### FIELD OF THE INVENTION

This invention relates to sensors, especially biosensors and to integrated semiconductor devices having a radiation detector such as a photodetector arranged to detect emissions from a sample, and to corresponding methods of manufacturing and using such devices. The present invention also relates to arrays of radiation detectors such as a photodetector and arrays of sample sites, and to corresponding methods of manufacturing and using such arrays.

### BACKGROUND OF THE INVENTION

Micro-fluidic devices are at the heart of most biochip technologies, being used for both the preparation of fluidic, e.g. blood based, samples and their subsequent analysis. Integrated devices comprising biosensors and micro-fluidic devices are known, e.g. under the name DNA/RNA chips, BioChips, GeneChips and Lab-on-a-chip. In particular, high throughput screening on arrays, e.g. micro-arrays, is one of the new tools for chemical or biochemical analysis, for instance employed in diagnostics. These biochip devices comprise small volume wells or reactors, in which chemical or biochemical reactions are examined, and may regulate, transport, mix and store minute quantities of liquids rapidly and reliably to carry out desired physical, chemical, and biochemical reactions and analysis in large numbers. By carrying out assays in small volumes, significant savings can be achieved in time and in costs of targets, compounds and reagents.

Generally, detection of fluorescence signals of a biochip is done using an optical detection system, comprising a light-source, optical filters and sensors (e.g. CCD camera), localized in a bench-top/laboratory machine, to quantify the amount of fluorophores present. A schematic illustration of such a sensor 10 is indicated in FIG. 1, showing a radiation source 14, for irradiating a sample 16 on a substrate 18. The resulting fluorescence signals are collected using optics 22 in a detector element 12. The fluorescence detection systems used in bench-top/laboratory machines furthermore generally require expensive optical components to acquire and analyse the fluorescence signals. Typically a filter for filtering the excitation radiation 20 and a filter 24 for separating the excitation radiation from the fluorescence response is needed. In particular, expensive optical filters with sharp wavelength cut-off, i.e. filters that are highly selective, are used to obtain the needed sensitivity of these optical systems, as often the shift between the excitation spectrum (absorption) and emission spectrum (fluorescence) is small (<50 nm). The latter is illustrated in FIG. 2. Consequently, the main sources of noise in a fluorescence based optical system are reflection of (a part of) the excitation light and (Rayleigh) scattering of the excitation light.

In many biotechnological applications, such as molecular diagnostics, there is a need for biochips comprising an optical sensor, or an array of optical sensors, that detect fluorescence signals and can be read-out in parallel and independently to allow high throughput analysis under a variety of (reaction) conditions. Advantages of biochips incorporating the optical sensor are, among others that on-chip fluorescence signal acquisition system improves both the speed and the reliability of analysis chips, eg DNA chip hybridisation pattern analysis, that costs are reduced for assays, that high portability is obtained e.g. by obtaining portable hand-held instruments for applications such as point-of-care diagnostics and roadside testing (i.e. no central bench-top machine needed anymore), that the fluorescent intensity can be enlarged as the solid angle of collection increases and that the number of medium boundaries and corresponding reflections decreases.

A bench-top machine will become able to handle versatile biochips and a multiplicity of biochips. Having the optical sensor as part of the bench-top machine demands the mounting of a specific filter set for a specific assay, which hampers the parallel (multiplexed) detection of fluorescent labels with various excitation and/or emission spectra. Therefore, being able to read-out on-chip optical sensor(s) allows for a flexible multi-purpose bench-top machine and opens the route towards standardization of biochips, bench-top machines, and components thereof. Nevertheless, the need for filters makes such biochips expensive, which is especially disadvantageous if disposable biochips are considered.

In Nucleic Acids Research 32 (2004), Fixe et al. describes a biochip with integrated optical sensors. The detection system uses an expensive filter for filtering out the excitation light, whereby the detection sensitivity is limited due to the filtering.

In numerous biotechnological applications, such as molecular diagnostics, there is a need for biochemical modules (e.g. sensors, PCR), comprising an array of temperature controlled compartments that can be processed in parallel and independently to allow high versatility and high throughput.

An object of the invention is to provide improved sensors, especially biosensors and to provide improved integrated semiconductor devices having a radiation detector such as a photodetector arranged to detect emissions from a sample, and to provide corresponding methods of manufacturing and using such devices.

### SUMMARY OF THE INVENTION

The invention is defined by the independent claims. Dependent claims define advantageous embodiments.

By providing a reflector according to the invention, a ratio of desired detection of emissions to unwanted detection of the illumination radiation, e.g. illumination light, can be improved. This can be achieved by a reduction in an amount of the illumination reaching the radiation detector, e.g. photodetector, and/or by an increase in the amount of radiation, e.g. illumination, of the sample and thus in the amount of emissions reaching the detector. This can be achieved more cost effectively than by using a wavelength filter. The radiation, e.g. illumination, can be from an external radiation source or in principle it can be provided by a radiation source integrated on the device. The radiation, e.g. illumination, can be visible or invisible wavelengths of the electromagnetic spectrum, according to the type of emissions being stimulated, e.g. far infra red, infra red, visible, ultra violet, far ultraviolet. Likewise the radiation detector, e.g. photodetector, is intended to encompass detectors of visible or invisible wavelengths of the electromagnetic spectrum.

The excitation radiation reaching the detector may be less than 50%, preferably less than 25%, more preferably less than 10%, more preferably less than 1%. The site may be a well wherein the sample may be positioned or may be a surface to which radiation emitting sample particles may be bound. The site thus may be a measurement region in a measurement chamber. The device can be implemented in the form of a microarray. The reflector for providing the excitation radiation to the sample site may be adapted for deflecting the excitation radiation onto the sample site. Alternatively, the reflector for providing the excitation radiation to the sample site may be adapted for generating evanescent field excitation radiation at the sample site.

An additional feature of some embodiments is the detector comprising a layer on a substrate, and the reflector being arranged to redirect radiation normal to the substrate to pass substantially parallel to the layer. This is a convenient way to increase the above mentioned ratio.

An additional feature of some embodiments is the device being a single use device. A single use device has the advantage that contamination can be reduced. For such devices it may be more important to keep costs down.

An additional feature of some embodiments is the device having an array of detection sites, each having a reflector, a radiation detector, e.g. a photodetector, and optionally having a radiation shield to shield the radiation detector, e.g. photodetector, from emissions from other samples. This can enable a device to be used for multiple tests simultaneously, either of the same type of test, or different types.

An additional feature of some embodiments is the reflector being formed by a prism or prismatic structure protruding from the substrate. Such structures can be integrated relatively easily. In principle the reflector could alternatively be sunk into the substrate if the substrate is transparent. Alternatively a reflector being formed by a prism or prismatic structure may be provided to a top layer, such that it faces the substrate with an edge.

Another additional feature of some embodiments is a mask over the sample sites and arranged to allow the excitation radiation, e.g. illuminating light, to reach the reflector and to substantially reduce the amount of excitation radiation reaching the detector. This can help improve the above mentioned ratio, or help avoid the need for careful alignment of a narrow beam of the illumination.

Another such additional feature is two or more reflectors on different sides of the same detector, arranged to deflect radiation, e.g. light, over the same detector. Again this can help improve the above mentioned ratio.

Another such additional feature is one reflector being arranged to deflect light over more than one detector. This can enable a higher level of integration, or simplify design and manufacture.

Another such additional feature is circuitry for selecting and reading from any of an array of the detectors. Again this can enable more detectors to be integrated and enable more tests or a variety of tests to be carried out simultaneously. The circuitry may be based upon large area electronics. In particular the electronics may include thin film transistors (TFTs) or other TFT devices such as diodes or photodiodes. Large area electronics technologies may be technologies based on amorphous silicon, low temperature poly-silicon and/or organic technologies.

Another such additional feature is respective ones of the sample sites comprising different types of biomolecules, such as different DNA samples, suitable for binding to analyte molecules, e.g. hybridizing with complementary DNA of various types. This can enable simultaneous testing for many different types of analyte molecules, e.g. different types of DNA, proteins.

Another such additional feature is the substrate being transparent or translucent, the radiation detector, e.g. photodetector being arranged on one side of the substrate, and the reflector being arranged on the same side of the substrate to reflect external light after passing through the substrate.

This arrangement enables the radiation detector, e.g. photodetector to face away from a source of external illumination, reducing the need for masking, or other countermeasures.

Another such additional feature is the radiation detector, e.g. photodetector, comprising a semiconductor material such as Si on an insulting substrate such as a glass substrate.

The integrated device according to embodiments of the present invention may be suitable for real-time polymerise chain reaction (PCR).

Other aspects of the invention include corresponding methods of manufacturing, and methods of using the devices.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the claims.

### BRIEF DESCRIPTION OF THE DRAWINGS

How the present invention may be put into effect will now be described by way of example with reference to the appended drawings, in which:

FIG. 1 is a schematic illustration of an optical setup to detect fluorescence signals coming from a biochip according to prior art.

FIG. 2 is an illustration of the overlap between an excitation spectrum and fluorescence spectrum due to a Small Stokes shift as often occurring in bio-chemical fluorescent assays, according to prior art.

FIG. 3 shows in cross section an embodiment of the invention with excitation light illuminating a prism from above,

FIG. 4 shows another embodiment where two prisms are created from a groove and the light illuminates the biosensor from below,

FIG. 5 shows a three quarter view of another embodiment having prisms incorporated in the active-matrix system with photo-sensors, and

FIGS. 6 and 7 show alternative shapes for the reflector.

FIG. 8 shows in cross-section an embodiment of the invention with excitation light illuminating a prism from above, wherein evanescent field excitation is performed.

FIG. 9 shows an exemplary detection unit of an integrated device based on large area electronics, according to an embodiment of the present invention.

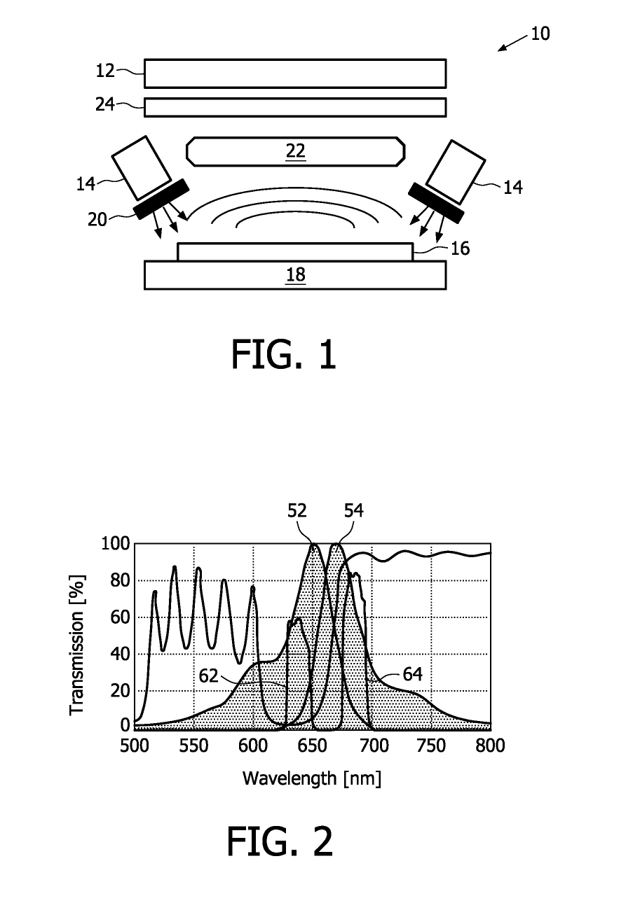

### DETAILED DESCRIPTION OF EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The present invention relates to sensors such as biosensors which comprise an array of radiation detectors, e.g. photodiodes, on a substrate, especially a transparent substrate. The sensor can be implemented in the form of a microarray.

In the present invention, devices and methods for sensing typically are adapted for sensing irradiation. Such irradiation may stem from restrained, or retained or immobilised molecules or particles as well as from non-immobilised probes, e.g. present in a liquid sample and not bounded to a surface. The devices and methods for sensing thus may be adapted for sensing or quantifying any of chemical, bio-chemical or biological molecules, e.g. particles. Such sensors may e.g. be used for real-time polymerase chain reaction (PCR). In real-time PCR, fluorescently labeled probes or DNA binding fluorescent dyes are used for detection and quantification of a PCR product, thus allowing quantitative PCR to be performed in real time. Whereas DNA binding dyes do not allow differentiation between specific and non-specific PCR products, fluorescently labeled nucleic acid probes have the advantage that they react with only specific PCR products. In case of real-time PCR typically a PCR primer starts to irradiate once it binds to a signal molecule. The latter typically may occur in a sample, without being bound to sites on a surface or substrate. Alternatively, in other applications such as other fluorescence based sensing and/or quantification techniques, the probes can be immobilised or attached to the sites by non-covalent or covalent bonding or may be mechanically restrained or retained, e.g. in a mesh or fibre structure.

The probes can be any suitable molecule or molecules, e.g. antibodies or binding fragments thereof, DNA or RNA, fragments of DNA or RNA, peptides, proteins, carbohydrates, cells, cell parts such as external or internal cell membranes or organelles, bacteria, viruses, etc. Also the probes may include combinations of these, e.g. cell proteins. If immobilisation of the probes is used in the sensing device or method, the surface of sites for the probes may be treated to obtain useful properties to allow immobilisation of the samples, e.g. the site surface may be made hydrophobic or hydrophilic. Typically such sites may be created by depositing or printing biomolecules as spots, such that when the spots are dried, the spot is in direct contact or aligned with the radiation detector. The biomolecules are preferably probes which bind to an analyte molecule whose presence is intended to be determined. General methods of attaching biological molecular probes to the surface of substrates are known the skilled person—see for example “Micorarray Technology and Its Application”, Müller and Nicolau, Springer, 2005, chapters 2 and 3. The spot area or probe site can be called a “pixel”. Spot deposition can be done by any suitable technique, e.g. contact or non-contact printing, microspotting, solid or split pin or quill printing, pipetting or thermal, solenoid or piezoelectric ink-jet printing of liquid samples, e.g. in the form of biomolecules. In accordance with embodiments of the present invention, probes adapted for irradiating typically are aligned with an array of a number of radiation detector sites. Sample comprising probes may be aligned with an array of a number of radiation detector sites and/or an array of a number of sites at which probes may be immobilised may be aligned with the array of radiation detector sites.

In addition light shields can be applied to shield light from neighbouring irradiating probes, positioned freely in the sample or immobilised at probe sites, e.g. to prevent cross-talk between different irradiating probes. The light shields can be combined with the use of the detector to provide detectors aligned with the sites for the spots, or independently of this.

Analyte molecules can be any molecules which need to be detected, e.g. DNA or RNA, fragments of DNA or RNA, peptides, proteins, carbohydrates, cells, cell parts such as external or internal cell membranes or organelles, bacteria, viruses, etc. To allow luminescence of the bound probes and analyte molecules, the probes and/or the analyte molecules can comprise or be attached to labels which provide the luminescence, e.g. by fluorescence, phosphorescence, electroluminescence, chemiluminescence, etc. When labelled, the probes or analyte molecules may be described as “optically variable molecules”. Once bound the light emission from the irradiating probe changes, e.g. it may emit chemiluminesce or it may emit fluorescence if excited with radiation of the correct wavelength. Other forms of light emission can be used, e.g. electroluminescence, with the present invention, e.g. by provision of the appropriate stimulant such as an electric current. Also, any suitable form of detection can be used, e.g. vertical optical direction, i.e. in a direction substantially perpendicular to a major surface of the substrate or, for example, lateral optical detection, e.g. with a shielded photodiode such that only light emanating from one irradiating probe is detected. This would enable crucial quality control in the manufacturing process of cartridges for medical diagnostic applications.

The embodiments described are concerned with an optical biosensor with integrated radiation detector, e.g. photodetector, and reflector. Particular embodiments show a disposable device having an optical biosensor incorporating a radiation sensor such as a photosensor, for instance based on active matrix (AM) technologies (e.g. Low Temperature PolySilicon—LTPS) commonly used in displays. These technologies help to address the problem of finding a cheaper way to suppress excitation light that will otherwise cause a background signal on the fluorescence detector (i.e. photo-sensor). Reflectors are mounted onto the disposable device to direct the excitation light over (away from and not onto) the photo-sensor. The redirected excitation light may be used for exciting the sample. Alternatively, by redirecting the excitation light, evanescent field excitation radiation may be generated at a sample position near a reflector and this evanescent field excitation radiation thus may be used for exciting the sample.

The biosensor can be based on active matrix (AM) technology. An advantage of such a biosensor is that it can be used in a disposable form to perform different assays at the same time. Real-time PCR can be advantageously employed in implementations of the present invention, though many other test methods can be used. Real-time PCR as well as rapid cycle real-time PCR is described in “Rapid cycle real-time PCR”, Reischl, Wittwer, Cockerill, Springer Verlag, 2001, especially in the chapter entitled: “Applications and Challenges of Real-Time PCR for the Clinical Microbiology Laboratory”.

Where the present invention is applied to a disposable device, it is preferred that the device is cheap to manufacture. Some of the features of the present invention are based on recognition that the detection filters typically used in front of fluorescence detectors are expensive. The reflectors according to the present invention can provide a new, cheaper solution to suppress the excitation light reaching the detector. In principle the reflectors can be used as an alternative, or in combination with such detection filters. The reflectors can be prisms and direct the excitation light away from, i.e. aside or over (but not onto) the integrated photo-sensor. Either the reflected excitation light may be used for exciting the sample or generated evanescent field excitation radiation may be used for exciting the sample.

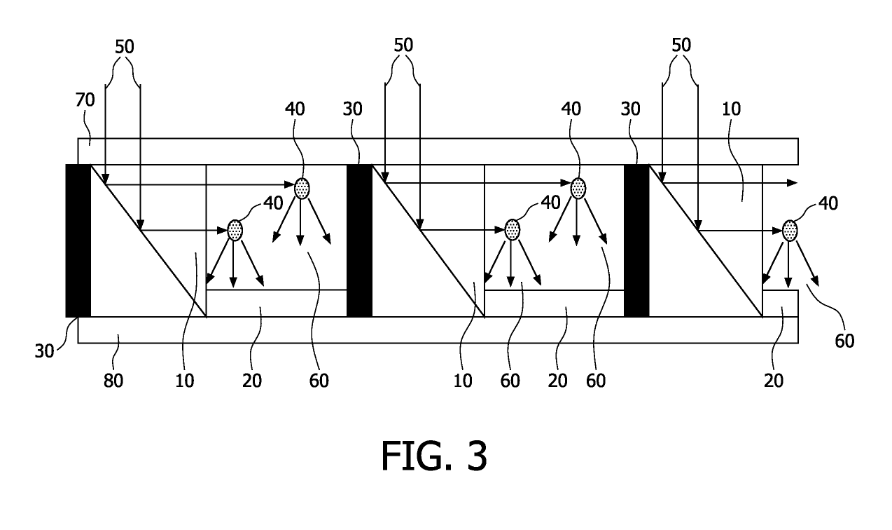

FIG. 3 shows an embodiment of the present invention in which excitation light 50 from an external source (not shown) illuminates a reflector in the form of a prism 10 from above. The prism redirects the excitation light towards an absorber/mirror 30 and fluorescence 60 emitted by the sample 40 comprising a probe, e.g. a biomolecule or biosample, is detected with a radiation detector such as a photodetector in the form of a diode 20. The diode is formed on a substrate 80, the prism can be attached to the substrate and/or to a top layer 70, for example, of the device. In the present embodiment, the probes may be present non-immobilised, e.g. in a sample such as e.g. a liquid sample for example provided in a well, or immobilised at binding sites. E.g. binding sites may be introduced between layers 70 and 80, using a substrate and/or using for example a porous medium. Air gaps can be provided to give some thermal insulation between samples.

In a basic embodiment excitation radiation, e.g. light, is illuminating the biosensor (for example from the top). Preferably, excitation light sources and optical paths are arranged so that the excitation light is only illuminating areas where no radiation detector is present. For example a collimated light source, or a mask with apertures in the top layer 70, can be used. In the illuminated areas, reflectors such as prisms are placed, which direct the light towards the samples 40 containing the probes. For example, the radiation, e.g. light, can be directed into the plane parallel to the biosensor surface. Due to this, the light is directed through the sample 40, e.g. a fluid having probes, that is present above the sensor, but because the direction is parallel to the sensor surface, the excitation light will not impinge on a light sensitive part of the sensor. In this way, the excitation light can excite the fluorophore probes that are present within the sample fluid above the sensor. Since the fluorescence is emitted in all directions, the sensor can detect a part of the generated fluorescence.

On the other side of the sensor, i.e. away from the reflector, the light can hit a boundary 30, such as for example a light-absorbing surface, a mirror for reflecting the light to let it make a 2nd pass through the fluid, or another prism, used to redirect the light back towards the source, or downwards, out of the disposable device.

Typically, the excitation light is only illuminating areas where no sensor is present, for example using a collimated light source. In another embodiment, a mask (e.g. black mask, reflective, etc.) is present on top or bottom of the disposable, such that only those areas are illuminated where no sensor is present. The source for the excitation light can be external or can be, for example, an LED or OLED integrated onto the top layer 70 above the reflector, e.g. prism in this case.

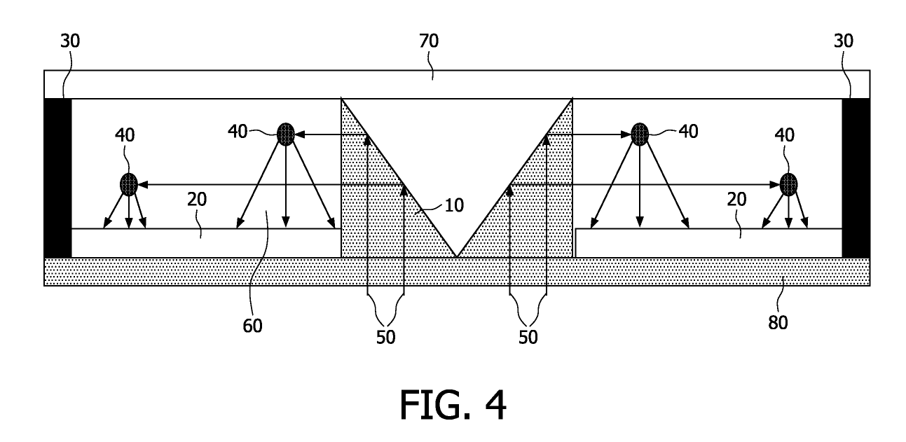

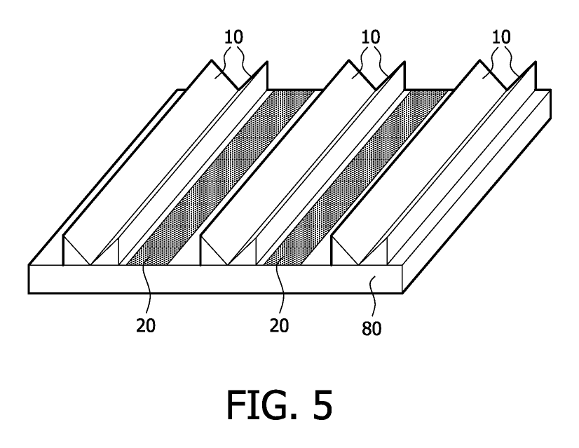

FIG. 4 shows a second example embodiment where two adjacent reflectors, e.g. prisms, are created from a channel or groove. The excitation light source is now arranged so that the excitation light illuminates the biosensor from below, implying the substrate 80 needs to be transparent. For example, the reflector such as the prism can be formed on the transparent substrate, or be cut from a block. Otherwise the device operates as described above for FIG. 3, and corresponding reference numerals have been used as appropriate. The source for the excitation light can be external or can be, for example, an LED or an OLED integrated onto the substrate under the reflector, e.g. prism in this case.

FIG. 5 shows a three quarter view showing how the reflectors, e.g. prisms, 10 can be incorporated in an active-matrix system with photo-sensors. In this case prisms 10 are shown in stripes on either side of an extended diode 20. Clearly this arrangement could be divided along its length to enable many detectors to be created. These could be individually addressed and selectable so that a user can identify which of the many detectors, or how many of them, are making positive detections. The detectors can be made individually addressable by providing at least one conductive line on the substrate to each of the detectors. Read-out electronic circuitry could also be integrated onto the substrate 80 to thereby facilitate read out of the detectors. Different samples could be placed above each of the detectors, e.g. diodes to enable different tests to be carried out simultaneously. In this embodiment, the samples can be illuminated from both sides to increase the amount of illumination.

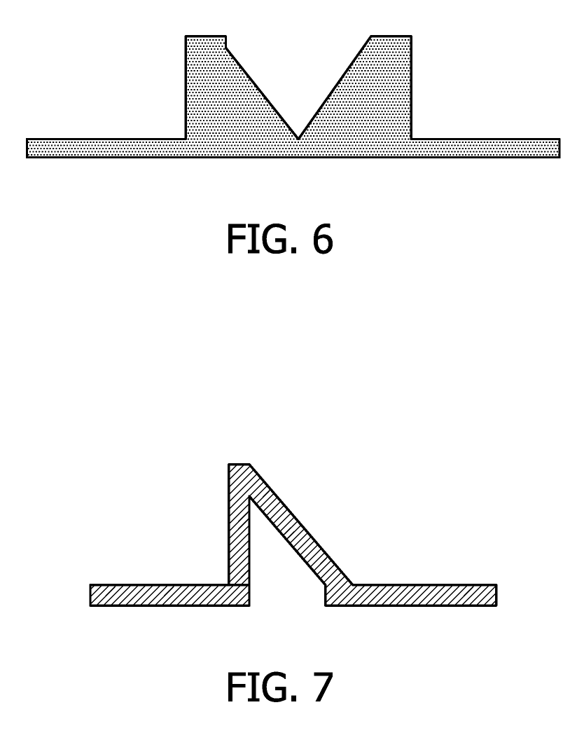

FIGS. 6 and 7 show reflectors having different shapes. In FIG. 6 a pair of prisms are shown to enable illumination from below. The tops of the prisms 10 are removed, thus providing each of the prisms with a flat top surface 110. As shown in FIG. 7, the reflector can be a mirror rather than a prism. It is to be noted that, in FIG. 6 and FIG. 7 the shields, as well as the detection elements have not been shown.

In any of the embodiments the reflector can be arranged at an angle to the plane of the substrate, e.g. the mirror or prism angle can be arranged so that the excitation light reflects at an angle above the horizontal to provide a margin of safety and ensure that no excitation light reaches the detector, e.g. diode. An absorber can be used to reduce any chance of excitation light reaching the reflector, e.g. mirror or prism, after a multiple reflection event. Furthermore, a prism or mirror with a curved reflection surface (with reflection at a progressively higher angle of elevation above the horizontal as one approaches the substrate comprising the diode) can maximize the volume to be excited whilst ensuring that no excitation light reaches the detector, e.g. diode. A similar effect can be achieved by multiple flat surfaces at progressive angles rather than a curve.

One reason for using multiple reflectors, e.g. mirrors or prisms, instead of one is that it is important that the distance between sensor and fluorophore is as small as possible, in order to get an optimized collection efficiency. A drawback of using multiple reflectors, e.g. mirrors or prisms, is that it may be difficult to produce very small reflectors, e.g. prisms or mirrors. Therefore, in other embodiments one reflector, e.g. prism or mirror, may be used for several diodes. Preferably, the distance between fluorophore and sensor remains relatively small. The advantage of this is that fewer reflectors, e.g. prisms or mirrors, are required and that the reflectors, e.g. prisms or mirrors may be bigger (and therefore easier to make).

In other embodiments multiple detectors, e.g. diodes may be used per reflector, e.g. prism or mirror. An advantage of this is that fewer reflectors, e.g. prisms or mirrors, are required and that the reflectors, e.g. mirrors or prisms may be bigger. It is also possible to use a 2D array of photo-sensors, for instance based on large area electronics (LTPS), and possibly arranged in a matrix, optionally an active matrix. In order to enhance the suppression of the excitation light, the detector, e.g. diode, can be equipped with a optical filter. Preferably, this filter is simple and cost effective.

Although, in the main embodiments prisms are described to redirect the light, it should be noted that mirrors will work just as well. Also, a prism does not necessarily need to have air next to it (as shown in the figures).

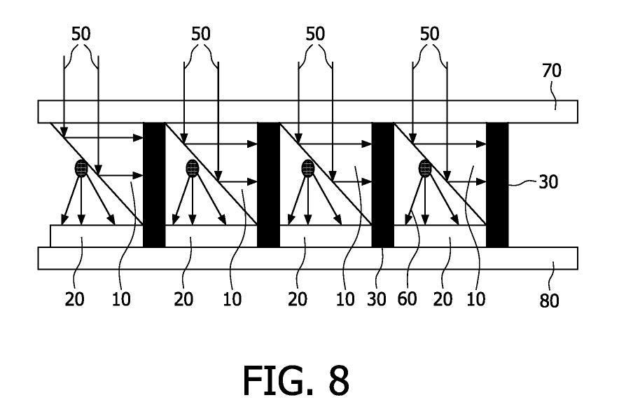

In a further embodiment of the present invention, a device according to any of the previous embodiments is shown whereby evanescent field excitation is generated by providing total internal reflection of an excitation radiation beam 50 at least one reflector 10, e.g. a prism, and whereby the evanescent field excitation is used for exciting the sample. Any suitable reflector 10 allowing generation of evanescent field excitation by providing total internal reflection may be used, such as e.g. a prism. Whereas the excitation beam 50 reflected at the at least one reflector 10 typically may be directed towards an absorber or mirror 30, near the reflector 10 evanescent field excitation is generated allowing to excite sample. The latter is illustrated by way of example in FIG. 8, indicating a device for detecting emission radiation, e.g. fluorescence 60, from a sample excited using evanescent field excitation radiation. In the present example, evanescent field excitation radiation is generated at a plurality of prisms. The prisms may be attached to the substrate 80 and/or a top layer 70. Typically, at least one radiation detector 20 may be used for detecting such emission radiation. Such at least one radiation detector 20 may be a photodetector in the form of a diode, e.g. formed on a substrate 80. In the present embodiment, preferably the sample is immobilised at binding sites near the reflector 10 in order for the sample to be in the evanescent excitation field. The absorber or mirror 30 may absorb or reflect at both sides, thus absorbing and/or reflecting excitation radiation and fluorescence radiation. An advantage of this arrangement is that there is an excellent separation between the excitation light and the fluorescence, because the angle of the prism is such that light essentially normal incident to the base of the prism is totally internally reflected at the prism medium interface and remains in the prism, while the fluorescence reaches the detector via the medium. Because of this automatic separation, there is less or no need for shielding the detector and the complete hypotenuse of the prism can be used for excitation, which can give a large useful binding area. Both wide field illumination and illumination by a focused/narrow beam (in that case scanning of the beam is required) are possible. Illumination by a focused/narrow beam has the advantage of a reduced excitation volume and thus improved SNR. One can think of a 2D array of prisms, with a matched array of spots/sources. By translating the array, one can probe the different prisms (with e.g., different adhesion layers etc. . . . ) in parallel.

In the present embodiment, the spacing in between the at least one reflector 10, e.g. prism, and the at least one detector 20 can be used as a fluidic channel for pumping the sample in the detector. Variations of the present embodiment include more than one detector per reflector, using only a single reflector, . . . .

In any of the above described embodiments, the device can be implemented using LAE (large area electronics) such as poly-Si or a-Si technology on a suitable insulating substrate such as glass. The substrate is preferably transparent or translucent, e.g. glass. Traditional large area electronics (LAE) technology offers electronic functions on an insulating substrate such as glass. Glass is a cheap substrate and has the advantage for optical detection of being transparent. Active LAE poly-Si or a-Si substrates are proposed for this application, to detect which sample spots are emitting without the use of external photo-detectors. Standard LAE technology can be used integrating (at little or no extra costs) photo-diode or photo-TFT detectors together with the usual addressing TFTs and circuitry. As indicated above, the biological samples comprising probes can be placed by any suitable contact or non-contact method including microspotting, solid or split pin or quill printing, pipetting or thermal, solenoid or piezoelectric ink-jet printing of liquid which is then kept liquid in wells or can be dried. The samples can be any suitable probes such as DNA fragments/olignonucleotides, or any of a wide range of other biological elements for other applications. The biological samples (e.g. DNA-fragments) can be aligned with the photodetectors by having two regions next to each other, a hydrophobic and a hydrophyllic region. When a hydrophilic, e.g. water based, liquid sample is deposited or printed it automatically pulls itself over the hydrophilic region, and then dries or sets into a gel in alignment with this location. Alternatively the biological sample also can be present in non immobilised way, such as e.g. typically may be the fact for real-time PCR. In such applications, typically probes are labelled with fluorescent labels which allow to detect and quantify a PCR product in real time. Some embodiments can have a-Si photodiodes (or photo TFTs) integrated on the substrate.

The device can e.g. be used by exposing the sample, e.g. liquid sample, or by exposing a dried spot of the probe sample to an unknown sample containing a molecule to be identified, e.g. a DNA fragment. The unknown sample if it contains the relevant molecule will bind to the probes in the biological sample. For example, if the DNA fragment is complementary DNA to a DNA probe, hybridisation occurs and the sample becomes fluorescent when illuminated. This can be detected by the photodiode and used to confirm the presence of the given complementary type of DNA. Of course other applications can be envisaged, and other types of photo detector can be used. If e.g. real-time PCR is performed, typically fluorescent labelled oligonucleotide probes or DNA binding fluorescent dyes are used which react with specific, and in case of DNA binding dyes non-specific, PCR products allowing to detect and quantify them in real time. Contacting the probes, e.g. fluorescent labelled probes, with the analyte molecules, can be carried out manually or can be automated, e.g. by pneumatic pumps, electro-osmosis or by means of MEMS devices for driving fluids along microchannels into and out of the site. If needed, the temperature of the fluids and the site can be controlled precisely by heating elements, such as resistors.

The photodetector structure such as an a-Si PIN diode, can be arranged to protrude above the substrate main surface. For example an a-Si PIN diode is around 0.2-1.0 μm high and the biological sample comprising probes in many examples, once dried is <50 nm high. Hence the diode structure may protrude, and the reflector may need to protrude further or reflect the illumination at an angle of elevation rather than parallel to the substrate.

Integrated optical detection can give better robustness than using an external photo detector, especially for handheld applications, e.g. no moisture or contaminants can come between the spot and the detector. The detector should preferably be arranged so that it is sensitive to light from only one site (also called a pixel). Preferably, the pixels may be addresses individually, i.e. a detection system is provided that can distinguish each of the pixels individually. This helps enable quality control upon deposition. Such quality control can be crucial in the manufacturing and quality assurance of cartridges for medical diagnostics. Optionally a self test illumination feedback path between the illuminating light and the photo detector could be added.

The radiation detectors, e.g. photo-detector can be implemented based on active matrix principles. Such a device is preferably fabricated from one of the well-known large area electronics technologies, such as amorphous silicon (a-Si), low temperature poly silicon (LTPS) or organic technologies. A TFT (thin film transistor), diode or MIM (metal-insulator-metal) could be used as active element. The radiation detectors can be integrated in an active plate comprising both n- and p-type TFTs. The TFTs may be gate-biased in the off-state, or lateral diodes made in the same thin semiconductor film as the TFTs, or vertical diodes formed from a second, thicker, semiconductor layer. For good sensitivity vertical a-Si:H NIP diodes can be used, and these can be integrated into the addressing TFTs and circuitry. The system may be part of a basic array comprising an active matrix of addressing transistors and storage capacitors in conjunction with a photo detector. The capacitor allows the light to be integrated over a long frame period time period and then read out. This also allows other circuitry to be added such as the integration of the drive, charge integration, and read-out circuitry. The active matrix technology is used in the field of flat panel displays for the drive of many display effects e.g. LCD, OLED and electrophoretic displays. It provides a cost-effective method to fabricate biochemical modules such as disposable biochemical module. This is advantageous, as biochips, or alike systems, may contain a multiplicity of components, the number of which will only increase as the devices become more effective and more versatile.

The reflectors typically may be incorporated in the detection device by e.g. gluing or bonding such as vacuum bonding one or more reflectors, e.g. an array of reflectors, to the surface of the substrate wherein/whereon the detector elements are provided. The latter typically may be performed, after the surface of the detection device has been provided with a planarisation layer for flattening the surface to which the reflectors are connected. Another alternative to incorporate the reflector elements may be by gluing or bonding such as vacuum bonding, a layer or plate of transparent material such as e.g. glass or organic polymer material to the surface of the substrate wherein/whereon the detector elements are provided. The layer or plate then may be processed, such as for example but not limited to etching or laser processing, in order to form the reflectors, e.g. prisms, therein. Alternatively, the layer or plate may already be processed in advance.

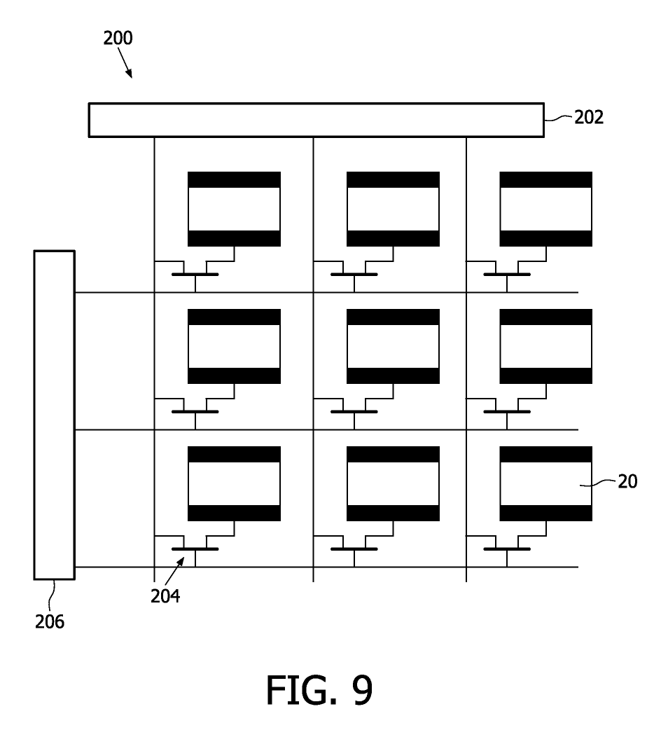

In the exemplary setup shown in FIG. 9, an active matrix, i.e. active matrix technology, is used as a distribution network to route the electrical signals detected by the radiation detectors 20 to a measurement unit 202 via individual signal lines, in this case in the form of column lines, the invention not being limited thereto, as part of circuitry 200 for selecting and reading from the radiation detectors 20. The exemplary setup shown is only provided by way of example, the invention not being limited thereto. In this example, the radiation detectors 20 are provided as a regular array of identical units, whereby the radiation detectors 20 are connected to the measurement unit 202 via the switches 204, e.g. transistors, of the active matrix. The control electrodes of the devices, e.g. gates of the transistors, are connected to a select driver 206 which could be configured as a standard shift register gate driver as used for an Active Matrix Liquid Crystal Display (AMLCD)), whilst the first electrode, e.g. source electrode, is connected to the radiation detector unit, for example a set of current or charge amplifiers. The operation of this array may e.g. be as follows:

To activate a given radiation detector 20, the switches 204, e.g. transistors, in the entire row of compartments incorporating the required radiation detector are switched into the conducting state (by e.g. applying a positive voltage to the control electrodes, e.g. gates, from the select driver).

The signal from the radiation detector is passed through the conducting switches, e.g. TFTs, to the measurement unit 202, where it is measured. It is also possible to probe more than one radiation detector 20 in a given row simultaneously by measuring the signals from all radiation detectors 20 in the line being addressed, providing the measurement unit 202 allows for this (i.e. it comprises a multiplicity of signal measurement devices).

After the signal has been measured, the switches 204, e.g. transistors, in the line are again set to the non-conducting state, preventing further measurement of the radiation detectors in that line.

As such, the matrix preferably operates using a “line-at-a-time” addressing principle, in contrast to the usual random access approach taken by CMOS based devices. It is possible to sequentially probe radiation detectors 20 in different rows by activating another line (using the select driver 206) and measuring the radiation detector 20 signals on one or more columns in the array.

Other variations and additions can be envisaged by those skilled in the art within the claims.

1. An integrated device for detecting radiation emissions from a sample when illuminated, the device having
a radiation detector (20),
a site for retaining the sample (40) adjacent to the radiation detector to enable detection of radiation emissions (60) from the sample and for receiving excitation radiation for impingement on the sample (40), and
a reflector (10) for providing the excitation radiation to the sample site and substantially guiding the excitation radiation away from the radiation detector.

2. The integrated device of claim 1, wherein the detector comprises a layer on a substrate (80), and the reflector (10) is arranged to redirect radiation normal to the substrate (80) to pass substantially parallel to the layer.

3. The integrated device of claim 1, wherein the device is a single use device.

4. The integrated device of claim 1 having an array of detection sites, each having a reflector (10), a radiation detector (20) and a radiation shield (30) to shield the radiation detector (20) from emissions from other samples.

5. The integrated device of claim 1, wherein the reflector (10) is a prism or a mirror.

6. The integrated device of claim 1, wherein a mask is arranged over the sample sites to allow the excitation radiation to reach the reflector (10) and to substantially reduce the amount of excitation radiation reaching the detector (20).

7. The integrated device of claim 1, wherein two or more reflectors (10) on different sides of the same detector (20), are arranged to deflect radiation over the same detector (20).

8. The integrated device of claim 1, wherein the reflector (10) is arranged to deflect radiation over more than one detector (20).

9. The integrated device of claim 1 having circuitry (200) for selecting and reading from any of an array of the detectors (20).

10. The integrated device according to claim 9, wherein said circuitry (200) is based upon large area electronics.

11. The integrated device of claim 1, wherein respective ones of the sample sites comprise different types of probes for binding to different types of molecules to be detected.

12. The integrated device of claim 2 wherein the substrate is transparent, the radiation detector is arranged on one side of the substrate, and the reflector is arranged on the same side of the substrate to reflect external radiation after passing through the substrate.

13. The integrated device of claim 1, wherein the radiation detector comprises Si on a glass substrate.

14. The integrated device of claim 1, wherein the reflector for providing the excitation radiation to the sample site is adapted for deflecting the excitation radiation onto the sample site.

15. The integrated device of claim 1, wherein the reflector for providing the excitation radiation to the sample site is adapted for generating evanescent field excitation radiation at the sample site.

16. A method of manufacturing an integrated device for detecting radiation emissions from a sample when illuminated, the method having the steps of forming a radiation detector (20) on a substrate (80), forming a site for retaining the sample (40) adjacent to the radiation detector to enable detection of emissions (60) from the sample, and forming a reflector (10) arranged to deflect the illumination onto the sample site and substantially guiding the excitation radiation away from the radiation detector.

17. The method of claim 16 the substrate being transparent, the steps of forming the radiation detector and the reflector being carried out to form both on the same side of the substrate, the reflector being arranged to reflect external radiation after passing through the substrate.

18. The method of claim 16 having the step of loading the sample site with a probe suitable for binding with a molecule in a sample (40) to be detected.

19. A method of using the device of claim 1 having the steps of adding a sample (40) to the sample site and illuminating the sample (40).
